(19) United States
(12) Patent Application Publication
(10) Pub. No.: US 2025/0118074 A1
(43) Pub. Date: Apr. 10, 2025

(54) ELECTRONIC DEVICE AND METHOD FOR EXTRACTING TIME POINT AT WHICH DESIGNATED MOTION IS CAPTURED

(71) Applicant: NCSOFT Corporation, Seoul (KR)

(72) Inventors: Youngik Kim, Seongnam-si (KR); Younghyun Lee, Seongnam-si (KR); Joonsoo Lee, Seongnam-si (KR); Hyunjo Jung, Seongnam-si (KR)

(73) Assignee: NCSOFT Corporation, Seoul (KR)

(21) Appl. No.: 18/982,059

(22) Filed: Dec. 16, 2024

Related U.S. Application Data
(63) Continuation of application No. PCT/KR2022/008660, filed on Jun. 17, 2022.

(51) Int. Cl. G06V 20/40; G06V 10/82

(52) U.S. Cl. CPC G06V 20/42; G06V 10/82

(57) ABSTRACT

An electronic device may include memory for storing instructions, and at least one processor operably coupled to the memory. The at least one processor, when the instructions are executed, is configured to receive a request for detecting a sound time point in a multimedia content when a designated motion is captured; obtain a distribution of probabilities in a time domain that the designated motion is performed based on an audio signal in the multimedia content, wherein the distribution of probabilities comprises a plurality of peak values corresponding to respective time points in the multimedia content; and obtain the sound time point when the designated motion is captured from among the respective time points corresponding to the plurality of peak values, using a video signal synchronized to the audio signal, in the multimedia content.

### CROSS-REFERENCE TO RELATED APPLICATION

This application is a continuation of the International Application No. PCT/2022/008660, filed on Jun. 17, 2022, at the Korean Intellectual Property Office, the disclosure of which is incorporated by reference in its entirety.

### 1. FIELD

The following descriptions relate to an electronic device and a method for extracting a time point at which a designated motion is captured.

### 2. BACKGROUND

In order to attract interest of a viewer, an electronic device is needed to provide a content by extracting a video in which a designated motion is captured. The electronic device may provide content, for example, a highlight video after the game is over, by extracting a video in which a designated motion is captured from a sports game video.

### SUMMARY

According to an embodiment, an electronic device may include memory for storing instructions, and at least one processor operably coupled to the memory. The at least one processor, when the instructions are executed, is configured to receive a request for detecting a sound time point in a multimedia content when a designated motion is captured; obtain a distribution of probabilities in a time domain that the designated motion is performed based on an audio signal in the multimedia content, wherein the distribution of probabilities comprises a plurality of peak values corresponding to respective time points in the multimedia content; and obtain the sound time point when the designated motion is captured from among the respective time points corresponding to the plurality of peak values, using a video signal synchronized to the audio signal, in the multimedia content.

According to an embodiment, a method of identifying a time point in a multimedia content, the method being executed by at least one processor of an electronic device may include receiving a request for detecting a sound time point in the multimedia content when a designated motion is captured; obtaining a distribution of probabilities in a time domain that the designated motion is performed based on an audio signal in the multimedia content, wherein the distribution of probabilities comprises a plurality of peak values corresponding to respective time points in the multimedia content; and obtaining the sound time point when the designated motion is captured from among the respective time points corresponding to the plurality of peak values, using a video signal synchronized to the audio signal, in the multimedia content.

A method of identifying one or more time points in a multimedia content, the method being executed by at least one processor of an electronic device may include receiving a request for detecting a sound time point in a multimedia content when a designated motion is captured; based on the receiving the request, identifying the sound time point when sound caused by the designated motion is captured, within an audio signal in the multimedia content; in response to identifying a time point having a value less than a threshold value within the audio signal, outputting information indicating that the identified time point is the sound time point when the designated motion is captured; and in response to identifying one or more time points having values above the threshold value within the audio signal and based on a video signal within different time intervals including the one or more time points, selecting a time point from among the one or more time points as the sound time point when the designated motion is captured.

### BRIEF DESCRIPTION OF THE DRAWINGS

FIG. 1 is a block diagram of an electronic device according to an embodiment.

FIG. 2 illustrates an example illustrating a neural network in which an electronic device obtains from a set of parameters, according to an embodiment.

FIG. 3 illustrates an example operation in which an electronic device extracts a video in which a designated motion is captured from a video, according to an embodiment.

FIG. 4 illustrates an example operation in which an electronic device identifies a peak value of probabilities that sound related to a designated motion is recorded based on an audio signal included in a video, according to an embodiment.

FIG. 5 illustrates an example process to obtain a time point corresponding to a peak value within an audio signal, according to an embodiment.

FIGS. 6A to 6C illustrate exemplary operations in which an electronic device identifies a time point corresponding to a peak value using the number of peak values included in an audio signal, according to an embodiment.

FIG. 7 illustrates an example in which an electronic device extracts objects through a neural network and tracks a position of a ball through the extracted objects, according to an embodiment.

FIG. 8 illustrates an example operation in which an electronic device selects one of a plurality of peaks included in an audio signal, using a trajectory of a ball identified based on a video signal, according to an embodiment.

FIG. 9 is a flowchart illustrating a process to detect a time point at which a designated motion is captured, according to an embodiment.

FIG. 10 is a flowchart illustrating process based on the number of peaks, according to an embodiment.

FIG. 11 is a flowchart illustrating a process for extracting a video in which a designated motion is captured from a video using a neural network, according to an embodiment.

### DETAILED DESCRIPTION

Specific structural or functional descriptions for embodiments according to the concept of the present disclosure disclosed herein are merely illustrative for the purpose of illustrating embodiments according to the concepts of the present disclosure, and the embodiments according to the concept of the present disclosure may be implemented in various forms and are not limited to the embodiments described herein.

The embodiments according to the concept of the present invention can be variously modified and have various forms, so that the embodiments are illustrated in the drawings and described in detail herein. However, this is not intended to limit the embodiments in accordance with the concept of the present invention to specific disclosure forms, and includes all the modifications, equivalents, and replacements included in the idea and technical scope of the present invention.

Although terms such as first, second, etc. may be used herein to describe various elements, these elements should not be limited by the terms. The terms are only used for the purpose of distinguishing one component from another component, for example, without departing from the scope of rights according to the concept of the present invention, the first component may be referred to as a second component, and similarly the second component may also be referred to as a first component.

When a component is referred to as “connected” or “accesses” to another component, it should be understood that another component may exist in the middle, although it may be directly connected to or assessed to the other component. On the other hand, when a component is referred to as “directly connected” or “directly connected” to another component, it should be understood that no other component exists in the middle. Expressions that describe the relationship between components, such as “between” and “right between” or “directly adjacent to”, should also be interpreted in the same manner.

The terms used herein are used only to describe specific embodiments and are not intended to limit the present invention. Singular expressions include plural expressions unless the context clearly indicates otherwise. In the present description, terms such as “comprise” or “comprising” are intended to designate that the features, numbers, steps, actions, components, parts, or combinations thereof exist, and should be understood not to preclude the existence or addition of one or more other features or numbers, steps, actions, components, parts, or combinations thereof.

Unless otherwise defined, all terms used herein, including technical or scientific terms, have the same meaning as those generally understood by those of ordinary skill in the art to which the present invention belongs. The terms such as those generally defined in a dictionary should be interpreted as having meaning consistent with the meaning in the context of the relevant technology and are not interpreted in an ideal or overly formal sense unless explicitly defined herein.

Hereinafter, embodiments will be described in detail with reference to the accompanying drawings. However, the scope of the claims is not limited or limited by these embodiments. The same reference numerals presented in each drawing represent the same members.

According to an embodiment, an electronic device that more accurately obtains a time point at which a designated motion is captured in a time domain, based on at least one of a video signal or an audio signal included in a video is provided. Furthermore, according to an embodiment, a method and an electronic device configured to implement the method in which the electronic device more accurately extracts a time point at which a designated motion is captured by using an audio signal is provided.

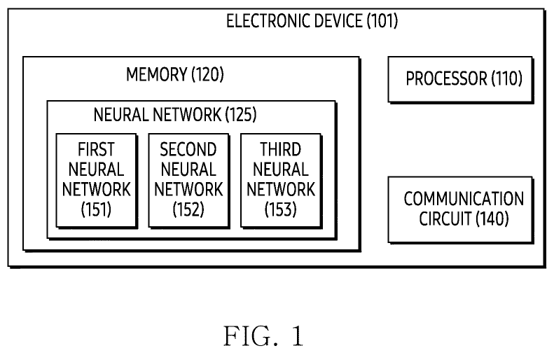

FIG. 1 is a block diagram of an electronic device according to an embodiment.

Referring to FIG. 1, an electronic device 101 according to an embodiment may include at least one of a processor 110, memory 120, and a communication circuit 140. The processor 110, the memory 120, and the communication circuit 140 may be electronically and/or operably coupled with each other by an electronic component such as a communication bus. A type and/or the number of hardware components included in the electronic device 101 is not limited as illustrated in FIG. 1. For example, the electronic device 101 may include only some of the hardware components illustrated in FIG. 1.

According to an embodiment, the processor 110 of the electronic device 101 may include a hardware component for processing data based on one or more instructions. For example, the hardware component for processing data may include an arithmetic and logic unit (ALU), a field programmable gate array (FPGA), and/or a central processing unit (CPU). The number of processors 110 may be one or more. For example, the processor 110 may have a structure of a multi-core processor such as a dual-core, a quad-core, or a hexa-core.

According to an embodiment, the memory 120 of the electronic device 101 may include a hardware component for storing data and/or instructions inputted and/or outputted to the processor 110. For example, the memory 120 may include volatile memory such as random-access memory (RAM) and/or non-volatile memory such as read-only memory (ROM). For example, the volatile memory may include at least one of dynamic RAM (DRAM), static RAM (SRAM), cache RAM, and pseudo-SRAM (PSRAM). For example, the nonvolatile memory may include at least one of programmable ROM (PROM), crasable PROM (EPROM), electrically crasable PROM (EEPROM), flash memory, a hard disk, a compact disk, and an embedded multi-media card (cMMC).

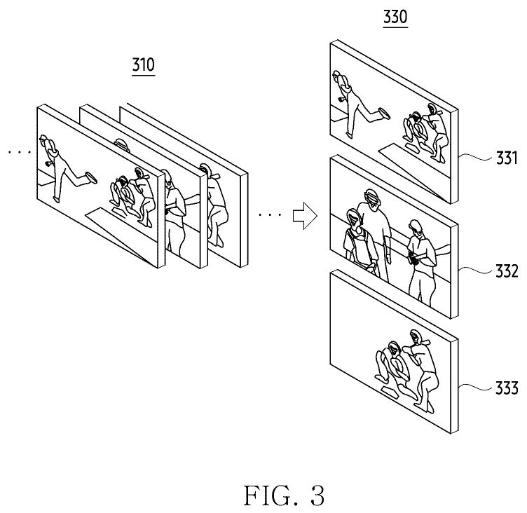

According to an embodiment, one or more instructions indicating an operation to be performed by the processor 110 on data may be stored in the memory 120 of the electronic device 101. A set of instructions may be referred to as firmware, an operating system, a process, a routine, a sub-routine and/or an application. For example, the electronic device 101 and/or the processor 110 of the electronic device 101 may perform at least one of operations of FIGS. 3 to 8 by executing a set of a plurality of instructions distributed in a form of an application.

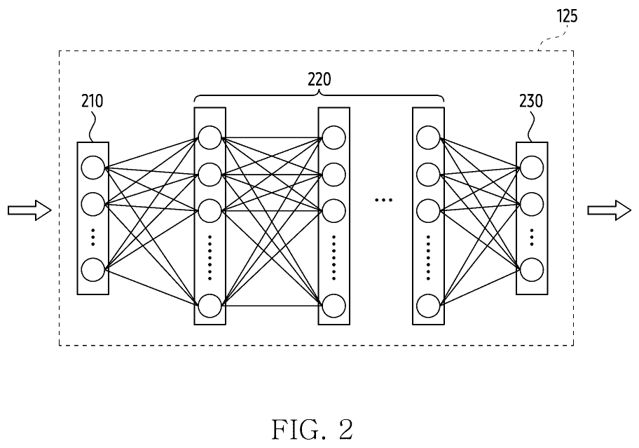

According to an embodiment, a set of parameters related to a neural network 125 may be stored in the memory 120 of the electronic device 101. The neural network 125 may be a recognition model implemented with software or hardware that mimics computing power of a biological system using a large number of artificial neurons (or nodes). The neural network 125 may perform cognitive action or a learning process of human through artificial neurons. For example, parameters related to the neural network 125 may represent a weight assigned to a plurality of nodes included in the neural network 125 and/or to a connection between the plurality of nodes. A structure of the neural network 125 represented by the set of parameters stored in the memory 120 of the electronic device 101 according to an embodiment may be described later with reference to FIG. 2. The number of neural networks 125 stored in the memory 120 is not limited to the one illustrated in FIG. 1 and sets of parameters corresponding to each of a plurality of neural networks may be stored in the memory 120.

According to an embodiment, the communication circuit 140 of the electronic device 101 may include a hardware component to support transmitting and/or receiving of an electrical signal between the electronic device 101 and an external electronic device. For example, the communication circuit 140 may include at least one of a modem (MODEM), an antenna, and an optic/electronic (O/E) converter. The communication circuit 140 may support the transmitting and/or receiving of an electrical signal based on various types of protocols such as Ethernet, a local area network (LAN), a wide area network (WAN), wireless fidelity (WiFi), Bluetooth, Bluetooth Low Energy (BLE), a ZigBee, a long-term evolution (LTE), and a new radio (5G NR).

According to an embodiment, the electronic device 101 may extract a video including a designated motion from a video using the neural network 125. The electronic device 101 may identify at least one external object included in the video from a video signal included in the extracted video. The electronic device 101 may identify a time point when a designated motion is captured based on identifying the external object. The electronic device 101 may identify sound indicating that a ball contacts at least one external object, from an audio signal included in the extracted video. For example, the electronic device 101 may adjust the time point when the designated motion is captured based on a time point when the sound is identified, by using the neural network 125. In an example, the captured time point may mean a time point of a video including a batting event included in a game video. The time point may be referred to as a batting time point, a catching time point, or a pitching time point. The designated motion may include at least one of a motion of pitching a ball or a motion in which the ball contacts at least one external object. The external object may include at least one of a glove, a bat, home plate, or equipment.

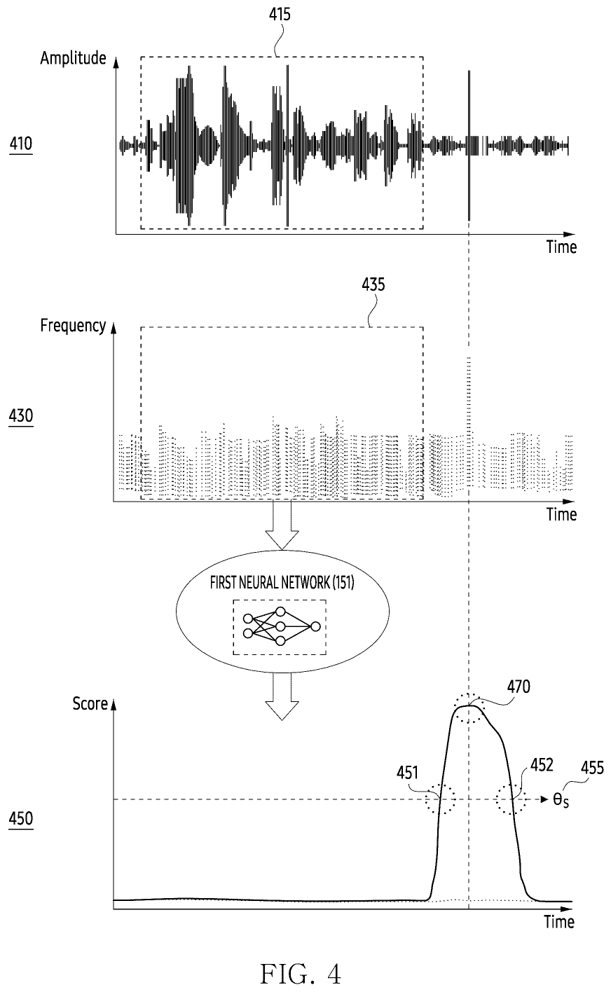

According to an embodiment, the memory 120 of the electronic device 101 include a plurality of neural networks. For example, a first neural network 151 may be an example of a neural network trained to identify at least one peak value within an audio signal included in a video. An operation in which the electronic device 101 identifies at least one peak value in the audio signal using the first neural network 151 is disclosed herein, for example, in FIG. 4. For example, a second neural network 152 may be an example of a neural network trained to identify a position of a ball based on an external object within a video signal included in a video.

According to an embodiment, the electronic device 101 may receive a vidco by establishing a communication channel with an external electronic device. The video received from the external electronic device may be a sports game video. The external electronic device may be broadcast cameras or a server transmitting videos received from the broadcast cameras to the outside by integrating and processes the videos. The image related to a position of a ball may be an image including the ball. For example, images related to the position of the ball may be captured images of a ball thrown from a pitcher to a catcher and/or a ball falling toward an outfielder or an infielder. In an example, the images related to the position of the ball may be images in which a ball disposed on a tecing ground and/or a field is captured. For example, a third neural network 153 may be an example of a neural network trained to obtain videos segmented by grouping according to a unit of shot or shots from the game video. At least one of the segmented videos may be multimedia content corresponding to a batting video and/or a catching vidco.

According to an embodiment, the electronic device 101 may train the first neural network 151 by receiving information on a time point when the designated motion is captured. The electronic device 101 may train the first neural network 151 through another neural network (e.g., the second neural network 152) distinguished from the first neural network 151. For example, the electronic device 101 may train the first neural network 151 by identifying the time point when the designated motion is captured, in a process of generating at least one video outputted through the second neural network 152. For example, the electronic device 101 may train the second neural network 152 using a time point corresponding to a peak value outputted through the first neural network 151.

According to an embodiment, the electronic device 101 may receive at least one video (e.g., the video of the sports game) using the neural network 125. The electronic device 101 may extract a video different from the received at least one video from the received at least one video, based on the neural network 125. The different video may include one video of a batting video, a pitching video, a catching video, an advertisement video, a dugout video, a field video, or a video including an audience, an outfielder, and/or an infielder.

Hereinafter, a neural network 125, which an electronic device 101 according to an embodiment obtains, based on a set of parameters stored in memory 120 will be described with reference to FIG. 2.

FIG. 2 is an example that illustrates a neural network in which an electronic device obtains from a set of parameters stored in memory, according to an embodiment. A neural network 125 of FIG. 2 may include a first neural network 151 to a third neural network 153.

Referring to FIG. 2, the neural network 125 may include a plurality of layers. For example, the neural network 125 may include an input layer 210, one or more hidden layers 220, and an output layer 230. The input layer 210 may receive a vector (e.g., a vector having elements corresponding to the number of nodes included in the input layer 210) indicating input data. Signals generated by each of nodes in the input layer 210, generated by the input data may be transmitted from the input layer 210 to the hidden layers 220. The output layer 230 may generate output data of the neural network 125 based on one or more signals received from the hidden layers 220. For example, the output data may include a vector having elements corresponding to the number of nodes included in the output layer 230.

Referring to FIG. 2, the one or more hidden layers 220 may be positioned between the input layer 210 and the output layer 230 and may convert input data, transmitted through the input layer 210, into a value easy to predict. The input layer 210, the one or more hidden layers 220, and the output layer 230 may include a plurality of nodes. The one or more hidden layers 220 are not limited to topology based on illustrated feedforward and may be, for example, a convolution filter in a convolutional natural network (CNN), or a fully connected layer, or various types of filters or layers bound based on special functions or features. In an embodiment, the one or more hidden layers 220 may be a layer based on a recurrent neural network (RNN) in which an output value is inputted back to a hidden layer of the current time. In an example, the input layer 210, the one or more hidden layers 220, and/or the output layer 230 may be some layers of a transformer model. According to an embodiment, the neural network 125 may form a deep neural network by including numerous hidden layers 220. Training a deep neural network is called deep learning. A node included in the hidden layers 220 from among nodes of the neural network 125 is referred to as a hidden node.

The nodes included in the input layer 210 and the one or more hidden layers 220 may be coupled with each other through a connection line having a connection weight, and the nodes included in the hidden layer and the output layer may also be coupled with each other through the connection line having the connection weight. Tuning and/or training the neural network 125 may mean changing the connection weight between nodes included in each of the layers (e.g., the input layer 210, the one or more hidden layers 220, and the output layer 230) included in the neural network 125. For example, tuning of the neural network 125 may be performed based on supervised learning and/or unsupervised learning.

According to an embodiment, the electronic device may tune the neural network 125 based on reinforcement learning in the unsupervised learning. For example, the electronic device may change policy information in which neural network 125 uses to control an agent based on an interaction between the agent and an environment. The policy information is a rule in which the electronic device uses a neural network to determine the agent's action in the environment, and the electronic device may change the policy information of the neural network by training the neural network based on the interaction between the agent and the environment. For example, the policy information may be changed so that the agent determines the optimal actions and/or sequence of actions to achieve obtainable a reward and/or a goal. According to an embodiment, the electronic device may cause a change in the policy information by the neural network 125 in order to maximize the goal and/or the reward of the agent by the interaction.

FIG. 3 illustrates an example operation in which an electronic device extracts a video in which a designated motion is captured from a video, according to an embodiment. The operation of FIG. 3 may be an example of an operation in which the electronic device 101 of FIG. 1 and/or the processor 110 of FIG. 1 perform using at least one neural network (e.g., the third neural network 153 of FIG. 1).

According to an embodiment, the electronic device may receive a video 310 from at least one external electronic device. As an electronic device establishes a communication channel with an external electronic device, the video 310 may be a real-time video received to the electronic device. The video 310 may be a video composed by a screen change. The screen change may mean changing a video from a screen including at least one object of a continuous video to another screen including an object different from the object. In an example, a batting video 333 may include a screen changed from a pitching video 331. In an example, the batting video 333 may include a catching3. The screen change may be distinguished into a fade-out in which another screen is displayed while at least one screen disappears, an overlap in which at least one screen and another screen overlap in different directions, and/or a simple screen change.

According to an embodiment, the electronic device may use log information related to the video 310 to extract a video 330 in a unit of shot or shots from the video 310. For example, the electronic device may receive log information through at least one neural network or extract log information from a video provided from the external electronic device. For example, the log information may include at least one of a progress time of a game, the frame number of the video, progress information of the game, or screen information of the video.

According to an embodiment, the electronic device may separate the video 310 received from the external electronic device for each frame. For example, the electronic device may separate the video 310 received from the external electronic device in a unit of shot or shots. The separated video 330 in a unit of shot or shots may include a plurality of frames. For example, the unit of shot or shots may mean a video (e.g., a single cut scene of the video) captured with one device. For example, the video 310 may be formed by a combination of various videos, such as a video taken by a camera located at a catcher's point of view, a video taken by a camera located at a pitcher's point of view, and a video taken by an outfield camera. In an example, the unit of shot or shots may mean a section captured by a single camera among the combination of videos captured by the cameras. For example, the video 310 may include a first section including a video captured by a first camera and a second section including a video captured by a second camera in which a screen changed. The shot may mean a video of the first section or a video of the second section.

According to an embodiment, the electronic device may obtain multimedia content by classifying the video 330 or the frames in a unit of shot or shots. The multimedia content may be a set of similar videos. The pitching video 331, a close-up video 332, and/or the batting video 333 may be included in the multimedia content. In an example, the multimedia content may include an advertisement video, a field video, and/or a stand video. The electronic device may identify a video in which a ball moves among videos including a pitcher, a batter, and/or a catcher from among the video 330 in a unit of shot or shots. In an example, the electronic device may identify a video in which a ball moves among videos including an outfielder and/or the stand from among the video 330 in a unit of shot or shots. The electronic device may extract frames in which the ball is captured from among the frames. The extracted frames may be included in a batting video, a pitching video, a catching video, a home run video, and/or a fine play video.

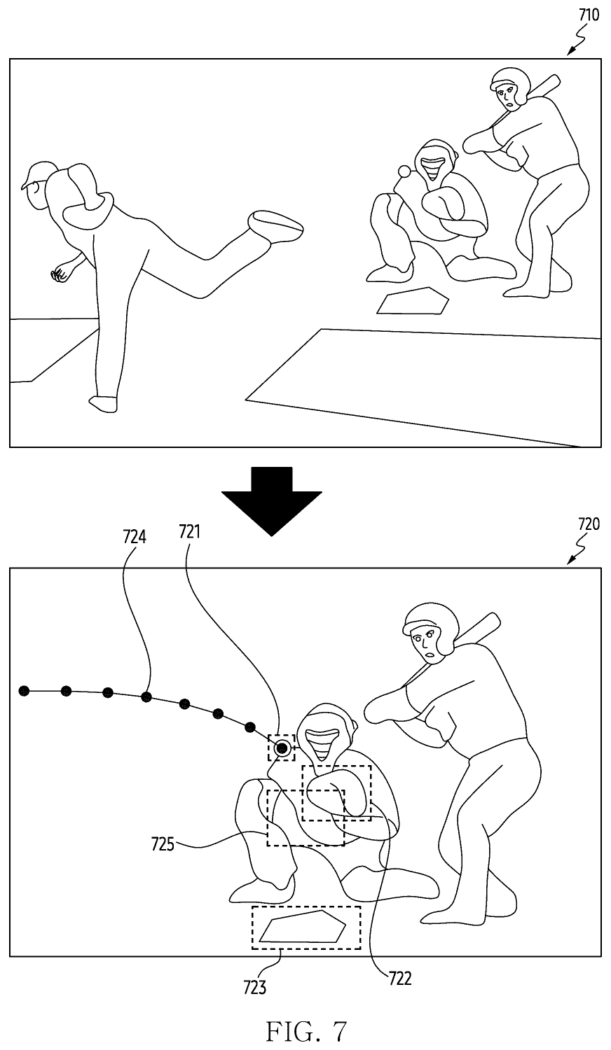

According to an embodiment, a processor of the electronic device (e.g., the processor 110 of FIG. 1) may extract multimedia content corresponding to a time point when the pitching video 331 is not identified, using log information related to the video 310, in case that the time point when the pitching video 331 is not identified exists from among time points (e.g., time points when a movement of the ball is identified) showed by the log information. For example, the processor may identify a time point that does not match the pitching video 331 or the frame among the time points of the log information, and further extract the pitching video 331 from the video 310 by using a difference between a video or a frame generated before and/or after the identified time point, and timestamp included in the log information of a pitch tracking device. The pitching video 331 and/or the batting video 333 may be a video in which at least one designated motion is captured. The designated motion may include at least one of a motion of pitching a ball or a motion in which the ball contacts a glove and/or a bat. An exemplary operation of obtaining at least one information from the pitch tracking device may be described later in FIG. 7.

According to an embodiment, the electronic device may obtain a video different from the pitching video 331, the close-up video 332, and/or the batting video 333 by extracting the video 330 in a unit of shot or shots from the video 310. The different video may include one of an advertisement video, a dugout video, or a video including an audience, an outfielder and/or an infielder.

As described above, the electronic device may receive a video from a server and/or an external electronic device, and group the video in a unit of shot or shots from the always received video. The electronic device may extract a video in which a designated motion is captured from the videos grouped in a unit of shot or shots. According to an embodiment, the electronic device may transmit a video signal and/or an audio signal included in the captured video to at least one neural network. An operation in which the electronic device identifies a peak value included in an audio signal using at least one neural network will be described later with reference to FIG. 4.

FIG. 4 illustrates an example operation in which an electronic device identifies a peak value of probabilities that a sound related to a designated motion is recorded with the peak value of probabilities being based on an audio signal included in a video, according to an embodiment. The operation of identifying the peak value may be performed by the electronic device 101 of FIG. 1 and/or the processor 110 of FIG. 1.

Referring to FIG. 4, a graph illustrating amplitude of an audio signal 410 according to a time domain is illustrated. According to an embodiment, the electronic device may extract the audio signal 410 from at least one video of the video 330 in a unit of shot or shots of FIG. 3. The audio signal 410 may be received to the electronic device in a.wav format. For example, the electronic device may identify a change of the amplitude in the time domain by receiving the audio signal 410. For example, the audio signal 410 included in a video (e.g., the batting video 333 of FIG. 3) may be an example of a signal obtained by at least one external electronic device disposed during a sports game. The audio signal 410 may include sound of a ball in contact with at least one external object including a glove or bat, a game commentary voice, and/or sound of an audience.

According to an embodiment, the electronic device may obtain characteristic information 430 from the audio signal 410. For example, the characteristic information 430 may include at least one of frequency or amplitude included in the audio signal 410 in the time domain. For example, referring to FIG. 4, a graph illustrating the characteristic information 430 as a spectrogram combining a waveform and a spectrum is illustrated. In an example, the waveform may mean a change in amplitude based on a change in time. The spectrum may mean a change in amplitude based on a change in frequency. The characteristic information 430 may include a change in amplitude based on the change in time and/or frequency.

According to an embodiment, the electronic device may obtain information 450 including a distribution of probabilities that a sound generated by a designated motion is captured in the time domain based on the characteristic information 430 obtained from the audio signal 410, using a first neural network 151. Referring to FIG. 4, a graph illustrating the information 450 according to the time domain is illustrated. For example, the distribution of probabilities included in the information 450 may include probabilities in which the sound (e.g., a sound indicating a ball coming in contact with at least one external object including a glove or bat, batting sound, a game commentary voice, sound of an audience, etc.) generated by the designated motion, corresponding to discrete times, is identified in the time domain. The distribution of the probabilities may represent the identifiable probabilities in the time domain as a score value between 0 and 1. The electronic device may obtain a score value based on the distribution of the probabilities. Based on the score value, the electronic device may identify at least one peak.

According to an embodiment, a processor (e.g., the processor 110 of FIG. 1) of the electronic device may transmit the characteristic information 430 to the first neural network 151. For example, the first neural network 151 may be included in the neural network 125 of FIG. 2. The first neural network 151 may include a structure of a convolutional neural network (CNN) and/or a current neural network (RNN). The first neural network 151 may include at least one of the input layer 210, the hidden layers 220 of FIG. 2, or the output layer 230 of FIG. 2. The electronic device may verify a time point when the sound generated by the designated motion is identified through the first neural network 151. The time point may be matched to a peak value 470.

According to an embodiment, the electronic device may identify the peak value 470 having a value exceeding a designated value using the first neural network 151. The designated value may correspond to a threshold value 455 (e.g., θₛ of FIG. 4). The electronic device may set the threshold value 455. For example, in case that the threshold value 455 is set to 0.5, the electronic device may identify values exceeding 0.5 based on the distribution of probabilities included in the information 450 through the first neural network 151. In an example, the electronic device may identify the largest value form among the identified values as the peak value 470. For example, the peak value 470 may be matched to the time point when the sound generated by the designated motion is captured. The peak value 470 may correspond to batting sound included in the video (e.g., the batting video 333 of FIG. 3).

According to an embodiment, the electronic device may obtain the time point when the designated motion is captured based on the time point when the peak value 470 is identified. The electronic device may train a neural network to obtain the captured time point. The electronic device may use a pre-trained neural network (e.g., the first neural network 151) to obtain the captured time point.

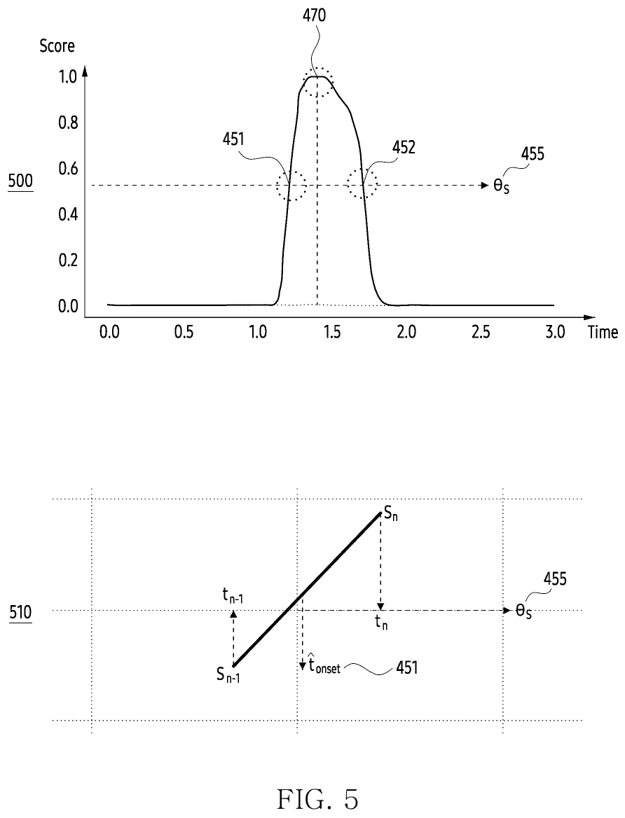

According to an embodiment, the electronic device may identify the time point when the peak value 470 is identified as a batting time point (or a catching time point). The batting time point may include a designated time. The designated time may be a time domain from a first time point 451 to a second time point 452. For example, referring to FIG. 4, the first time point 451 and/or the second time point 452 may mean a time point matched to the threshold value 455 in the distribution of probabilities included in the information 450. An exemplary operation in which the electronic device obtains a designated time may be described later with reference to FIG. 5.

According to an embodiment, the electronic device may identify noise 415 and 435 as sound different from the sound generated by the designated motion in the time domain based on the distribution of probabilities included in the information 450 in the time domain. In an example, the noise 415 and 435 may be matched to 0 in the distribution of probabilities included in the information 450. For example, the noise 415 and 435 may be an example of sound excluding sound in which the ball contacts at least one external object within the audio signal included in the video. The sound of the ball in contact with the at least one external object may be referred to as striking sound, hitting sound, and/or batting sound. Sound excluding the sound in which the ball in contact with the at least one external object may be an example of audience sound and/or a game commentary voice included in the video.

In an embodiment, the electronic device may obtain a fine play time point by identifying characteristic information including designated frequency. The fine play time point may be a time point different from at least one of a pitching time point and the batting time point. For example, the electronic device may identify a fine play video matched to the fine play time point based on a screen change generating after a pitching video (e.g., the pitching video 331 of FIG. 3) including the pitching time point, in the video (e.g., the video 310 of FIG. 3). For example, the electronic device may identify the sound of the audience included in the audio signal using the first neural network 151. The electronic device may train the neural network (e.g., the first neural network 151) based on frequency and/or amplitude corresponding to the sound of the audience. The electronic device may obtain a time point corresponding to the sound of the audience based on the fine play video by using the trained neural network. The obtained time point may be referred to the fine play time point.

As described above, the electronic device may obtain at least one batting sound through the audio signal included in the video. The electronic device may identify a time point when the batting sound included in the video is recorded, using the obtained batting sound. Hereinafter, an operation for obtaining a time point may be described with reference to FIG. 5.

FIG. 5 illustrates an example operation to obtain a time point corresponding to a peak value within an audio signal, according to an embodiment. The electronic device of FIG. 5 may correspond to the electronic device 101 of FIG. 1. The electronic device may use at least one neural network (e.g., the first neural network 151 of FIG. 1) to obtain a time point corresponding to the peak value within the audio signal.

According to an embodiment, the electronic device may extract characteristic information from an audio signal included in at least one video (e.g., the batting video 333 of FIG. 3) extracted from the video (e.g., the video 310 of FIG. 3). The electronic device may obtain a distribution of probabilities (e.g., a distribution of probabilities included in information 500) using the characteristic information. The information 500 may be referred to as the information 450 of FIG. 4. The electronic device may identify a peak including values exceeding a threshold value 455 based on the distribution of probabilities included in the information 500. The electronic device may identify the peak value 470, which is the largest value among the identified peaks. Although not illustrated, the electronic device may identify a plurality of peaks. A peak value 470 may be matched to batting sound, hitting sound, sound generated by contacting a ball with a glove, sound generated by contacting the ball with the ground, sound generated by contacting the ball with a bat, and/or sound generated by interaction of the ball with at least one external object included in the video, included in the audio signal. In an example, the peak value 470 may be a value obtained by the electronic device using a neural network trained to identify designated frequency and/or a wavelength included in the audio signal.

According to an embodiment, the electronic device may extract a time point when a designated motion is captured. The time point may include time points from a first time point 451 to a second time point 452. In an example, the first time point 451 may mean the initial value among values matched to the threshold value 455 in the distribution of probabilities included in the information 500. A slope of the distribution of probabilities matched to the first time point 451 may be positive. The second time point 452 may mean the last value among the values matched to the threshold value 455 in the distribution of probabilities included in the information 500. A slope of the distribution of the probabilities matched to the second time point 452 may be negative. In an example, the peak value 470 may mean a value matched to an intermediate time point among discrete points existing between the first time point 451 and the second time point 452 in the distribution of probabilities. The electronic device may identify a value in which a slope is positive number among the values matched to the threshold value 455 as the first time point 451 based on the distribution of the probabilities. The electronic device may identify a value in which a slope is a negative number among values matched to the threshold value 455 as a second time point 452 based on the distribution of the probability.

According to an embodiment, the electronic device may obtain the first time point 451 and/or the second time point 452 based on the neural network (e.g., the first neural network 151 of FIG. 1) using Equation 1 to be described later. A graph 510 may mean a portion from among the distribution of probabilities, matched to the first time point 451 and/or the second time point 452 in the information 500.

$${\hat{t}}_{onset} = {t}_{n} \pm \frac{\vert {s}_{n} - {θ}_{s} \vert}{\vert {s}_{n} - {s}_{n - 1} \vert} \cdot ( {t}_{n} - {t}_{n - 1} ) \qquad Eqn ( 1 )$$

In the Equation 1 described above, \hat{t}ₒₙₛₑₜ may mean a time point corresponding to the first time point 451 and/or the second time point 452 distinguished by the ‘±’ operation. For example, in case that a sign (e.g., ± of the Equation 1) is ‘−’, the sign may mean the first time point 451. In case that the sign is ‘+’, \hat{t}ₒₙₛₑₜ may mean the second time point 452. tₙ or tₙ₋₁ may mean one of discrete times in the time domain. For example, tₙ₋₁ may mean a time before a time corresponding to tₙ. sₙ or sₙ₋₁ may mean one of the values (e.g., the score value of FIG. 5) of the probability distribution in the time domain. For example, sₙ and/or sₙ₋₁ may mean a score value corresponding to tₙ and/or tₙ₋₁ in the distribution of probabilities included in the information 500. θₛ may mean the threshold value 455. According to an embodiment, the electronic device may obtain the first time point 451 and the second time point 452 included in the batting video 333 using the Equation 1 described above.

According to an embodiment, the electronic device may obtain the time point when the designated motion is captured based on Equation 2 using at least one of the first time point 451 and the second time point which are obtained.

$$\{ \begin{matrix}\begin{matrix}{\hat{t}}_{audio} = {\hat{t}}_{onset} + ( \frac{{M}_{1}}{{M}_{1} + {M}_{2}} ) \cdot ( {\hat{t}}_{offset} - {\hat{t}}_{onset} ) , & {s}_{max} \geq {θ}_{s}\end{matrix} \\ \begin{matrix}{\hat{t}}_{audio} = {t}_{max} , & {s}_{max} < {θ}_{s}\end{matrix} \\ \\ \end{matrix} \qquad Eqn ( 2 )$$

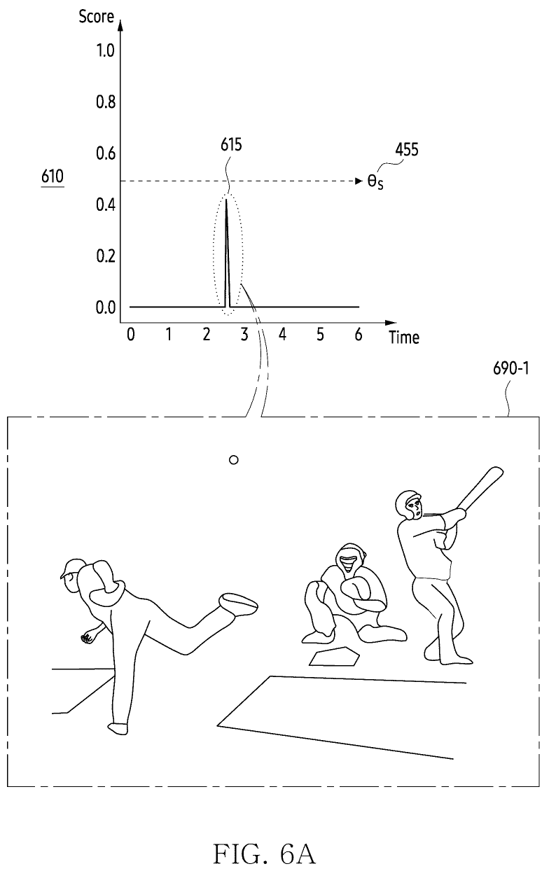

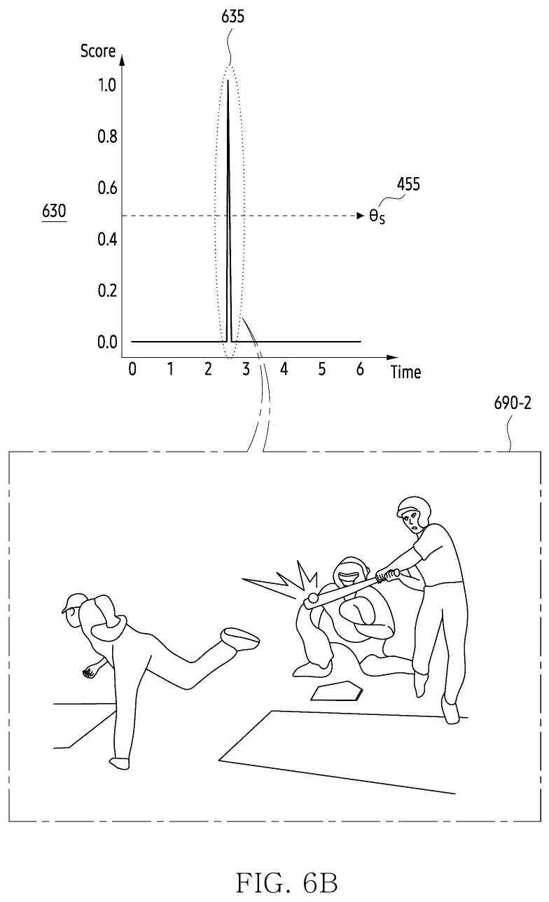

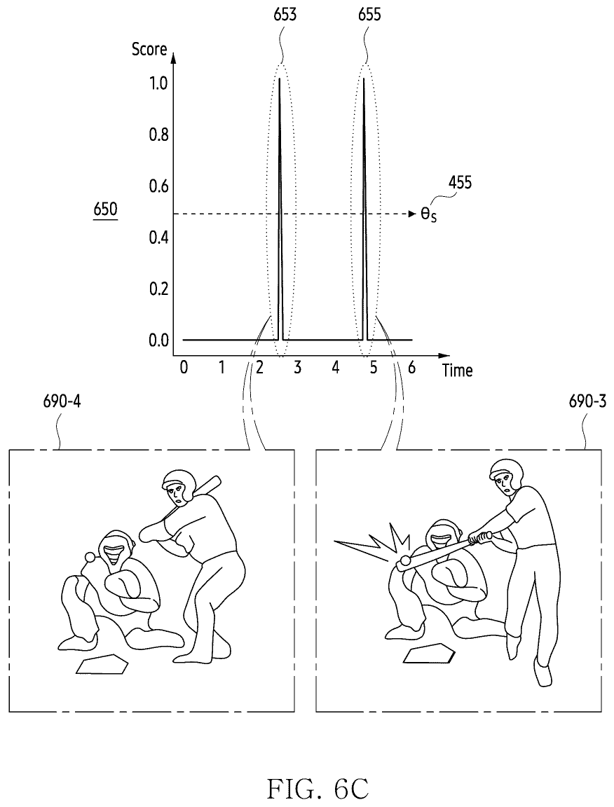

In the Equation 2 described above, \hat{t}_{audio} may mean the time point corresponding to sound generated by the ball contacting at least one external object. M₁ and/or M₂ may mean a designated value. The electronic device and/or the processor may set M₁ and/or M₂. \hat{t}_{offset} may be referred to as a second time point 452. \hat{t}ₒₙₛₑₜ may be referred to as a first time point 451. sₘₐₓ may mean the largest value from among the values (e.g., the score of FIG. 5) of the distribution of probability included in the information 500. θₛ may mean the threshold value 455. tₘₐₓ may mean a time point corresponding to the largest value from among a plurality of values in information (e.g., information 610 of FIG. 6A) including values smaller than the threshold value 455. According to an embodiment, the electronic device may obtain a time point when the designated motion is captured using the Equation 2.

According to an embodiment, the electronic device may identify the peak value 470 having the largest value from among a plurality of values exceeding the threshold value. The electronic device may identify a designated time including a time point corresponding to the peak value 470 as a batting time point and/or a catching time point using at least one neural network. The designated time may mean a time domain from the first time point 451 to the second time point 452. The electronic device may extract a video or a frame corresponding to the time domain from among a batting video (e.g., the batting video 333 of FIG. 3) or a plurality of frames including a batting event.

According to an embodiment, the electronic device may identify sound corresponding to the peak value 470 as batting sound. The batting sound may include at least one of sound generated by contacting a pitched ball with a glove, sound generated when a batter bats, sound generated when a catcher is in contact with the ground by missing the ball or sound generated by contacting with equipment behind home plate. The electronic device may identify a video and/or a frame corresponding to the time point when the batting sound is generated and/or recorded using the identified batting sound. The identified video and/or frame may be included in the batting video (e.g., the batting video 333 of FIG. 3). For example, the first time point 451 may be a time point corresponding to an image (or a screen) ahead of the time point corresponding to the peak value 470 by a designated frame. In an example, the second time point 452 may be a time point corresponding to an image later by a designated frame than a time point corresponding to the peak value 470. However, it is not limited thereto.

As described above, the electronic device may obtain a batting time point and/or a catching time point using the Equation 1 and/or the Equation 2 based on whether a peak value is identified based on an audio signal included in the batting video, through at least one neural network. The electronic device may obtain a plurality of batting time points and/or a plurality of catching time points when receiving a plurality of multimedia contents. The electronic device may combine batting videos corresponding to the plurality of obtained batting time points and provide them to a user. The electronic device may combine the obtained catching videos based on the plurality of catching time points and provide them to the user. In FIGS. 6A to 6C to be described later, an operation in which the electronic device obtains a time point corresponding to a peak based on the number of identified peaks will be described.

FIGS. 6A to 6C illustrate example operations in which an electronic device identifies a time point corresponding to a peak value using the number of peak values included in an audio signal, according to an embodiment. The operation of identifying a plurality of peaks included in FIGS. 6A to 6C may be performed by the electronic device 101 of FIG. 1 and/or the processor 110 of FIG. 1. Information 610, information 630, and/or information 650 may correspond to the information 500 of FIG. 5. Peaks 615, 635, 653, and 655 may correspond to different time points respectively. However, it is not limited to the embodiment described above. For example, screens 690-1, 690-2, 690-3, and 690-4 may correspond to at least one frame included in the batting video 333 of FIG. 3. In an example, batting videos including the screens 690-1, 690-2, 690-3, and 690-4 may be different from each other.

Referring to FIG. 6A, a graph illustrating a distribution of probabilities including at least one peak 615 having a value less than a threshold value 455 in the information 610 is illustrated. The distribution of probabilities included in the information 610 may include probabilities where sound generated by a designated motion is identified in a time domain. According to an embodiment, the electronic device may identify the at least one peak 615. The electronic device may identify the peak 615 receiving an audio signal, based on at least one neural network (the first neural network 151 of FIG. 1), using the Equation 1 and/or the Equation 2. In an example, the largest value of the distribution value (e.g., the score of FIG. 6A) of the probabilities included in the peak 615 may be a value less than the threshold value 455. The electronic device may obtain a time point corresponding to the largest value of the peak 615. The obtained time point may be matched to a time point when batting sound is recorded. The electronic device may extract a frame corresponding to the obtained time point from at least one video (e.g., the batting video 333 of FIG. 3). The frame may be referred to the screen 690-1. The screen 690-1 may be an example of a screen corresponding to an audio signal, including sound generated by contacting a ball with at least one external object among a plurality of frames included in the at least one video received to the electronic device. The screen 690-1 may be an example of a screen after the pitched ball is in contact with a bat. For example, the screen 690-1 may be a screen matched to the end frame (e.g., a frame matched to the second time point 452 of FIG. 4). The electronic device may obtain a video including the screen 690-1 based on the time point corresponding to the largest value of the peak 615.

Referring to FIG. 6B, a graph illustrating the distribution of probabilities including at least one peak having a value greater than or equal to the threshold value 455 in the information 630 is illustrated. According to an embodiment, the electronic device may identify one peak 635 having a value exceeding the threshold 455 by receiving an audio signal, using at least one neural network. For example, the electronic device may obtain a batting time point from the identified peak 635 using the Equation 1 and/or the Equation 2. For example, the electronic device may identify a batting time point from the received video, using the peak 635. For example, the electronic device may identify frames corresponding to the batting time point from at least one video (e.g., the batting video 333 of FIG. 3) from among a video in a unit of shot or shots (e.g., the video 330 in a unit of shot or shots of FIG. 3). At least one of the identified frames may be referred to the screen 690-2. The screen 690-2 may be a portion of a video signal matched to an audio signal in which sound generated by contacting a ball pitched by a pitcher with at least one external object is recorded. The electronic device may obtain a start frame (e.g., a frame matched to the first time point 451 of FIG. 4) and/or an end frame (e.g., a frame matched to the second time point 452 of FIG. 4) from among a plurality of frames included in the received video, using the Equation 1 and/or the Equation 2. In an example, the electronic device may obtain a video configured to a plurality of frames from the start frame to the end frame from the received video. The video configured to the plurality of frames may be an example of a segmented video from the batting video.

Referring to FIG. 6C, a graph illustrating a distribution of probabilities including a plurality of peaks in the information 650 is illustrated. According to an embodiment, the electronic device may receive an audio signal using at least one neural network to identify a plurality of peaks 653 and 655 included in the audio signal. The plurality of peaks 653 and 655 may be matched to at least one of batting sound or noise (e.g., the noise 415 and 435 of FIG. 4). For example, the peak 653 may be matched with characteristic information on sound including the same amplitude and/or frequency as the peak 655 matched to the batting sound. For example, a time point matched to the peak 653 may be a time point when sound of an audience included in a video (e.g., the batting video 333 of FIG. 3) is recorded. A screen matched to the peak 653 may be a screen in which the electronic device identifies a ball, using at least one neural network (e.g., the second neural network 152 of FIG. 1) like the screen 690-4. For example, in case of identifying the plurality of peaks, the electronic device may select one peak using a video signal included in the pitching video (e.g., the pitching video 331 of FIG. 3), based on the at least one neural network (e.g., the second neural network 152 of FIG. 1). The selected peak may be a peak matched to a pitching time point. A time point matched to the selected peak may correspond to the pitching time point obtained by the electronic device using a video signal. For example, the electronic device may obtain the pitching time point based on whether a ball included in the video signal is identified using the video signal.

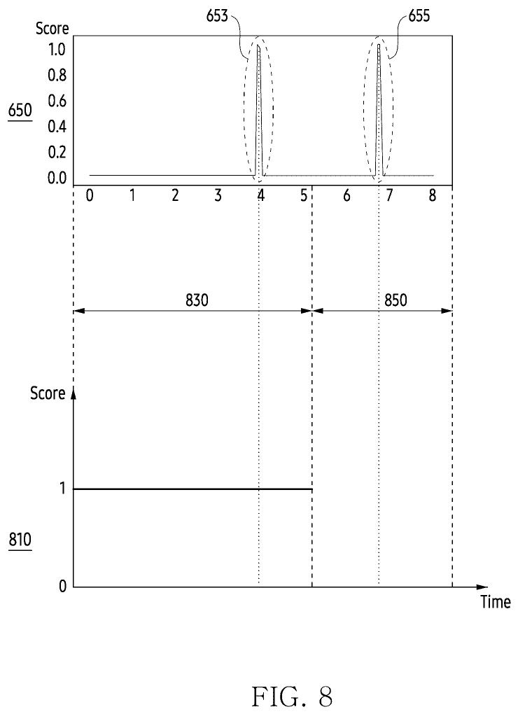

According to an embodiment, in case of identifying the plurality of peaks 653 and 655, the electronic device may identify the peak 655 matched to the batting time point obtained from a video signal based on the at least one neural network. The electronic device may obtain a batting time point based on a time point corresponding to the matched peak 655. The electronic device may identify at least one of a trajectory of a ball, a strike zone, a pitcher position, a catcher position, or home plate to obtain a pitching time point from the video signal. The electronic device may obtain a batting time point included in the video signal based on the identification. An operation in which the electronic device selects one of a plurality of peaks based on the identification may be described later with reference to FIG. 8. For example, a frame including the batting time point may be referred to the screen 690-3. In an example, the electronic device may segment the batting video (e.g., the batting video 333 of FIG. 3), using the time point included in the peak 655 (e.g., the first time point 451 of FIG. 4 and the second time point 452 of FIG. 4).

According to an embodiment, the electronic device may extract a start time point (e.g., the first time point 451 of FIG. 4) of the video and an end time point (e.g., the second time point 452 of FIG. 4) of the video using the Equation 1 from the peak 655. For example, the electronic device may obtain a batting time point using the Equation 2 based on the obtained time point. The electronic device may crop the video using the start time point of the video and/or the end time point of the video. The cropped video may include at least one of the batting time point and/or a catching time point. For example, the start time point of the video may be matched to a screen including at least one of a situation in which the pitcher prepares to throw a ball or a situation of exchanging sign between the pitcher and the catcher. The end time point of the video may be matched to a screen including a situation after the ball pitched by the pitcher is contact with at least one external object. The situation after the contact may include at least one of a situation in which a batter rushes, a situation in which the batter throws a bat, a situation in which the catcher picks up a ball that has fallen to the ground, a situation in which the catcher throws a ball, or a situation in which the catcher rushes toward equipment placed behind the home plate.

As described above, the electronic device according to an embodiment may perform an operation of obtaining a batting time point based on the number of peaks identified from an audio signal included in a video. The electronic device may use a video signal included in the video to obtain a batting time point from the audio signal. The electronic device may separate the video based on the batting time point obtained from the audio signal. The electronic device may provide the separated video matched to an accurate batting time point to a user. Hereinafter, in FIG. 7, an operation in which an electronic device tracks a pitched ball by identifying at least one of a plurality of objects included in a video will be described.

FIG. 7 illustrates an example in which an electronic device extracts objects through a neural network and tracks a position of a ball through the extracted objects, according to an embodiment. The neural network of FIG. 7 may include the second neural network 152 of FIG. 1. Screens 710 and 720 may be included in the pitching video 331 and/or the batting vidco 333 of FIG. 3.

Referring to FIG. 7, the electronic device (e.g., the electronic device 101 of FIG. 1) according to an embodiment may identify an area (e.g., a Ball-Zone) including an area including a pitching position, a catching position, and a position for requesting a catcher from a screen 710 including the pitching video, using the neural network (e.g., the second neural network 152 of FIG. 1). As on the screen 720 of FIG. 7, the electronic device according to an embodiment may visualize the identified area using the neural network. In an example, the electronic device may receive information from a pitch tracking device through the neural network. The pitch tracking device may be an example of a device obtaining data related to a trajectory of a ball. The pitch tracking device may be a pitch tracking system (PTS) and/or a device configuring a pitch tracking system. The pitch tracking device may provide information generated by tracking a movement of a baseball in a stadium. According to an embodiment, the electronic device may obtain data related to a position of the ball by establishing a communication channel with the pitch tracking device through a communication circuit (e.g., the communication circuit 140 of FIG. 1).

According to an embodiment, the electronic device may identify an external object of the screen 710 including the pitching video using the neural network to obtain a screen 720 on which the identified external object is displayed. For example, the neural network may identify the external object included in the Ball-Zone, which is represented by home plate, a batter, and/or a catcher. The neural network may output information representing the screen 720 on which the identified external object is displayed by a bounding box, a dot, and/or a line. According to another embodiment, if it is possible to provide the pitching video on the screen 710 including the pitching video, the neural network may omit an extraction operation of a screen (e.g., the screen 720) including the ball-zone.

According to an embodiment, the electronic device may identify a visual object related to a pitch in the extracted screen 710 using the neural network. For example, the neural network may identify the ball, the catcher, the batter, and/or the home plate. The neural network may identify a pitching position 721, a glove 722, and/or home plate 723 based on the identified external object.

According to an embodiment, the electronic device may generate a strike zone 725 including a virtual plane based on the home plate 723 and a physical condition of the batter, using the neural network. The neural network may form the strike zone 725 with the home plate 723 as the width of the strike zone 725, and as the height of the strike zone 725 from the batter's knee to the waist.

According to an embodiment, the electronic device may overlap a video and an image including the identified pitching position 721, a glove 722, and a home plate 723, or a video or an animation representing a trajectory 724 of the ball on a screen.

According to an embodiment, the electronic device may obtain at least one of a moving trajectory of the ball, a pitching position, a position for requesting a catcher, and/or a catching position from the extracted pitching video (e.g., the pitching video 331 of FIG. 3) from among the video in a unit of shot or shots (e.g., the video 330 in a unit of shot or shots of FIG. 3). The electronic device may identify a position of the ball captured in each of a plurality of frames included in the pitching video. The electronic device may identify at least one of the pitching position, the position for requesting a catcher, the catching position, and a batting position, based on the identified position of the ball. The electronic device may identify the position of the ball at designated time points using the neural network. For example, the electronic device may identify a strike zone by identifying the home plate and the batter included in the pitching video. The electronic device may identify the position of the ball passing through a plane including the strike zone as a pitching position. The electronic device may identify an external object including the catcher's glove and/or the batter's bat based on the neural network to identify a time point when the ball and the external object interact. The interacting time point may be an example of a time point when the ball and the external object contact. The time point may be an example of a pitching time point, a batting time point, a catching time point, or a time point matched to the peak value 470 of FIG. 4, included in the pitching video or the batting video. The electronic device may identify the position of the ball interacting with the external object as a catching position or a batting position.

According to an embodiment, the electronic device may obtain the trajectory 724 of the ball by connecting the identified positions of the ball in a plurality of frames included in the pitching video using the neural network. In case that the ball is covered by the bat (e.g., a swing and miss), or in case that the ball overlaps with an external object having a color similar to a color of the ball, the trajectory 724 of the ball obtained using the neural network may not fully represent a movement of the ball captured by the frames. An operation in which the electronic device selects at least one of the plurality of peaks 653 and 655 of FIG. 6C based on a time point when a ball is identified will be described later in FIG. 8.

According to an embodiment, in case that the trajectory 724 is terminated in a frame prior to the betting time point and/or the catching time point, the electronic device may extend the trajectory 724 to a frame at the betting time point and/or the catching time point. For example, the electronic device may identify, by extending the trajectory 724 based on the ball's speed of movement represented by the trajectory 724 between frames, the position of the ball in the frame at a time point when designated sound (e.g., at least one of sound generated by a collision between the bat and the ball, sound generated by a collision between the glove and the ball, batting sound, or hitting sound) is recorded. The designated sound may be matched to the peak value 470 of FIG. 4. The electronic device extending the trajectory 724 is not limited to the above example, and may be performed, for example, based on pitch tracking system (PTS) information. The PTS information may be included in log information.

FIG. 8 illustrates an example operation in which an electronic device selects one of a plurality of peaks included in an audio signal, using a trajectory of a ball identified based on a video signal, according to an embodiment. The electronic device of FIG. 8 may be referred to the electronic device 101 of FIG. 1. Information 650 may correspond to the information 650 of FIG. 6C. A plurality of peaks 653 and 655 may correspond to the plurality of peaks 653 and 655 of FIG. 6C. The electronic device may use a neural network (e.g., the first neural network 151 of FIG. 1) in order to obtain a distribution of probabilities from an audio signal included in a batting video (e.g., the batting video 333 of FIG. 3). The electronic device may use a neural network different from the neural network (e.g., the second neural network 152 of FIG. 1) in order to obtain a trajectory of a ball (e.g., the trajectory 724 of FIG. 7) from the video signal included in a pitching video (e.g., the pitching video 331 of FIG. 3). Referring to FIG. 8, a graph illustrating the distribution of probabilities in which the ball included in information 810 is identified according to a time domain is illustrated.

According to an embodiment, the electronic device may obtain the trajectory of the ball based on identifying a plurality of external objects (e.g., at least one of the pitching position 721 of FIG. 7, the glove 722 of FIG. 7, the home plate 723 of FIG. 7, and/or the strike zone 725 of FIG. 7) captured from a plurality of frames included in the pitching video. The electronic device may obtain a distribution of probabilities in which the ball is identified in a time domain, by using the trajectory of the ball, by using at least one neural network. For example, the electronic device may obtain 1 (e.g., score value) in a first section 830 in which the ball is identified from among the distribution of probabilities. The electronic device may obtain 0 in a second section 850 in which the ball is not identified from among the distribution of probabilities. In an example, a case that the electronic device does not identify the ball, may include at least one case of a case that the ball is covered by the bat and a case the ball overlaps an external object with a color similar to the color of the ball, or at least one case that the ball disappears from the pitching video by contacting the ball with an external object.

According to an embodiment, the information 650 and the information 810 may include the same time domain. For example, a time point matched to the peak 653 may be included in a time domain corresponding to the first section 830. The time domain may include a plurality of time points. The time point matched to the peak 655 may be included in a time domain corresponding to the second section 850. While the electronic device identifies the ball using the neural network (e.g., the second neural network 152 of FIG. 1) in the first section 830, the electronic device may identify the peak 653 included in the audio signal using a neural network different from the neural network (e.g., the first neural network 151 of FIG. 1). The electronic device may identify that the identified peak 653 is not a sound generated by contacting the ball with an external object. In an example, the peak 653 may mean characteristic information of sound including frequency and/or amplitude similar to the sound generated by contacting the ball with the external object.

According to an embodiment, the electronic device may identify, while the ball may not be identified using a neural network in the time domain corresponding to the second section 850, the peak 655 included in the audio signal using a neural network different from the neural network. The electronic device may identify the peak 655 as sound matched to batting sound. The electronic device may separate at least one of a pitching video, a batting video, a catching video, or a video signal included in videos based on time points (e.g., the first time point 451 of FIG. 4 and the second time point 452 of FIG. 4) matched to the peak 655, using Equation 1 and/or Equation 2. The separated videos or the separated video signal may be any one of a set of a video corresponding to the time domain or frames corresponding to the time points.

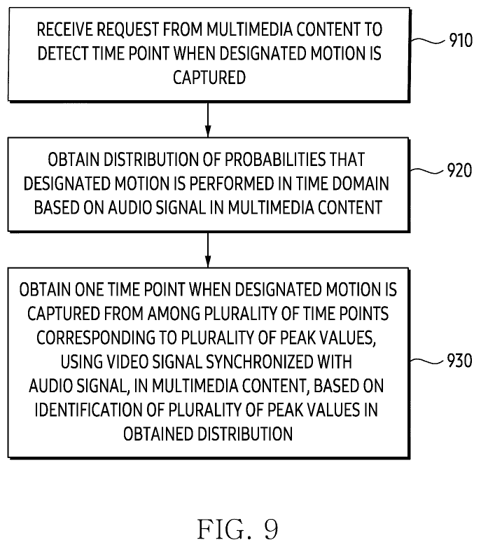

FIG. 9 is a flowchart illustrating a process in which an electronic device detects a time point at which a designated motion is captured, according to an embodiment. The operation of FIG. 9 may be performed by the electronic device 101 of FIG. 1 and/or the processor 110 of FIG. 1.

Referring to FIG. 9, in operation 910, a processor according to an embodiment may receive a request from multimedia content to detect a time point when a designated motion is captured. The multimedia content may include the video 330 in a unit of shot or shots of FIG. 3. The designated motion may include at least one of a motion in which a pitcher pitches a ball or a motion in which the ball contacts a glove and/or a bat. The time point when the designated motion is captured may include a pitching time point, a catching time point, and/or a batting time point included in a pitching video. The request to detect may mean an input by a user of the electronic device.

Referring to FIG. 9, in operation 920, the processor according to an embodiment may obtain a distribution of a probabilities that the designated motion is performed in a time domain based on an audio signal in the multimedia content. For example, the audio signal may correspond to the audio signal 410 of FIG. 4. The distribution of probabilities may be included in the information 450 of FIG. 4. For example, the processor may obtain the audio signal with the distribution of probabilities in the time domain, based on at least one neural network (e.g., the first neural network 151 of FIG. 1). The distribution of probabilities may mean a set of probabilities in which sound generated by the designated motion is identified, matched to each time point included in the time domain.

Referring to FIG. 9, in operation 930, the processor according to an embodiment may obtain one time point when the designated motion is captured from among a plurality of time points corresponding to the plurality of peak values. The processor may use a video signal synchronized with the audio signal in the multimedia content, based on the identification of a plurality of peak values in the obtained distribution. The plurality of peak values may refer to a value corresponding to a plurality of peaks 653 and 655 of FIG. 6C. The value corresponding to the plurality of peaks may refer to the largest value among the values of the plurality of peaks. The video signal may include information in which the processor identifies the trajectory of the ball (e.g., the trajectory 724 of FIG. 7) based on at least one neural network (e.g., the second neural network 152 of FIG. 1). The video signal synchronized with the audio signal may mean a time domain included in the information 810 matched to the same time domain included in the information 650 in FIG. 8. The processor may identify the peak 655 of FIG. 8, generated for a time corresponding to the second section 850 of FIG. 8, with information corresponding to the batting sound. The processor may obtain a time point matched to the batting sound, based on a neural network (e.g., the first neural network 151 of FIG. 1) different from the at least one neural network, using Equation 1 of FIG. 5 and/or Equation 2 of FIG. 5. The batting sound may include a hitting sound, and sound generated by an interaction of the ball with an external object including at least one of a glove, a bat, home plate, or equipment. The processor may separate a video (e.g., the pitching video 331 of FIG. 3 or the batting video 333 of FIG. 3) based on the obtained time point, using Equation 1 and/or Equation 2.

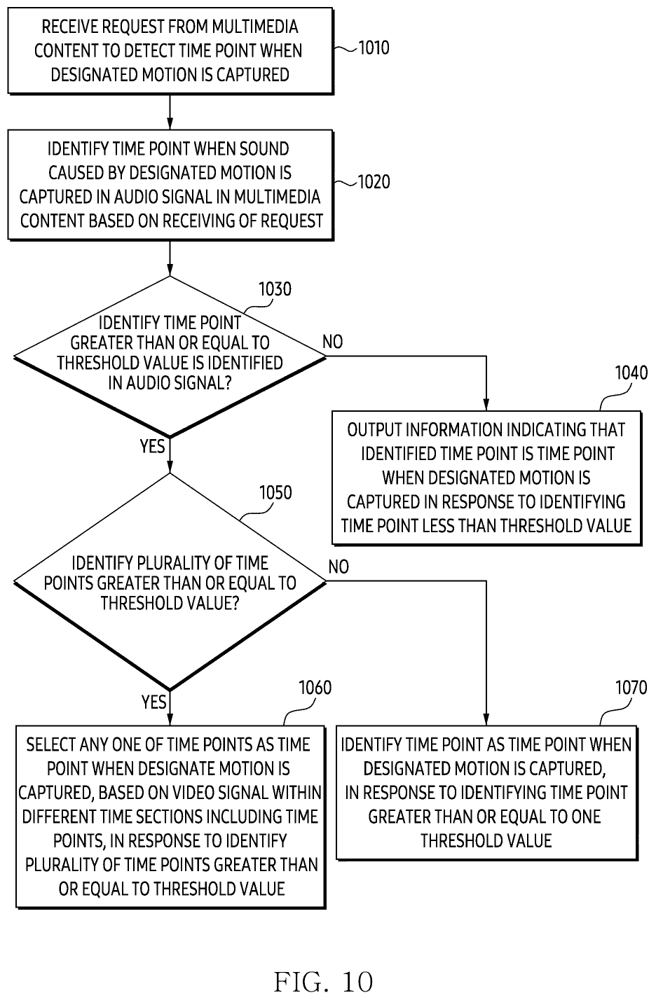

FIG. 10 is a flowchart illustrating a process based on the number of peaks, according to an embodiment. The operation of FIG. 10 may be performed by the electronic device 101 of FIG. 1 and/or the processor 110 of FIG. 1.

Referring to FIG. 10, in operation 1010, a processor according to an embodiment may receive a request from multimedia content to detect the time point when the designated motion is captured. The processor may perform operation 1010 similar to the operation 910 of FIG. 9.

Referring to FIG. 10, in operation 1020, the processor according to an embodiment may identify a time point when sound caused by the designated motion is captured in the audio signal in the multimedia content based on the receiving of the request. For example, the audio signal may include the audio signal 410 of FIG. 4 and/or the characteristic information 430 of FIG. 4. The processor may obtain a distribution of probabilities (e.g., the distribution of probabilities included in the information 450 of FIG. 4) based on the audio signal using at least one neural network (e.g., the first neural network 151 of FIG. 1). The designated motion may include at least one of a motion of throwing a ball or a motion in which the ball interacts with at least one external object. Sound caused by the designated motion may be an example of sound generated by the ball contacting at least one external object. The captured time point may be a time point corresponding to the peak value 470 of FIG. 4.

Referring to FIG. 10, in operation 1030, the processor according to an embodiment may identify whether a time point greater than or equal to a threshold value is identified in the audio signal. The threshold value may be referred to the threshold value 455 of FIG. 4. The time point greater than or equal to the threshold value may correspond to the peak value 470 of FIG. 4.

Referring to FIG. 10, when (1030-No) it is not possible to identify a time point greater than or equal to the threshold value in the audio signal, in operation 1040, the processor according to an embodiment may output information indicating that the identified time point is a time point when the designated motion is captured in response to identifying a time point less than the threshold value. The identified time point may be matched to the peak 615 of FIG. 6A. The information indicating the time point when the designated motion is captured may mean a batting time point corresponding to a peak. The processor may obtain the betting time point based on at least one neural network (e.g., the first neural network 151 of FIG. 1), using Equation 1 and/or Equation 2.

Referring to FIG. 10, when (1030-Yes) a time point greater than or equal to a threshold value is identified in the audio signal, in operation 1050, the processor according to an embodiment may determine whether to identify a plurality of time points greater than or equal to the threshold value. For example, the processor may identify whether to use a video signal, based on the number of time points greater than or equal to the threshold value.

Referring to FIG. 10, in case (1050-Yes) of identifying a plurality of time points greater than or equal to the threshold value, in operation 1060, the processor according to an embodiment may select any one of the time points as the time point when the designate motion is captured. This is based on a video signal within different time sections including the time points, and may be in response to identifying the plurality of time points greater than or equal to the threshold value. The video signal may include the information 810 of FIG. 8. The time points may be referred to the peaks 653 and 655 of FIG. 6C. The different time sections may correspond to the first section 830 and/or the second section 850 of FIG. 8.

Referring to FIG. 10, when (1050-No) it is not possible to identify a plurality of time points greater than or equal to the threshold value, in operation 1070, the processor according to an embodiment may identify the time point as the time point when the designated motion is captured, in response to identifying a time point greater than or equal to one threshold value. For example, the time point greater than or equal to the one threshold value may be matched to the peak 635 of FIG. 6B.

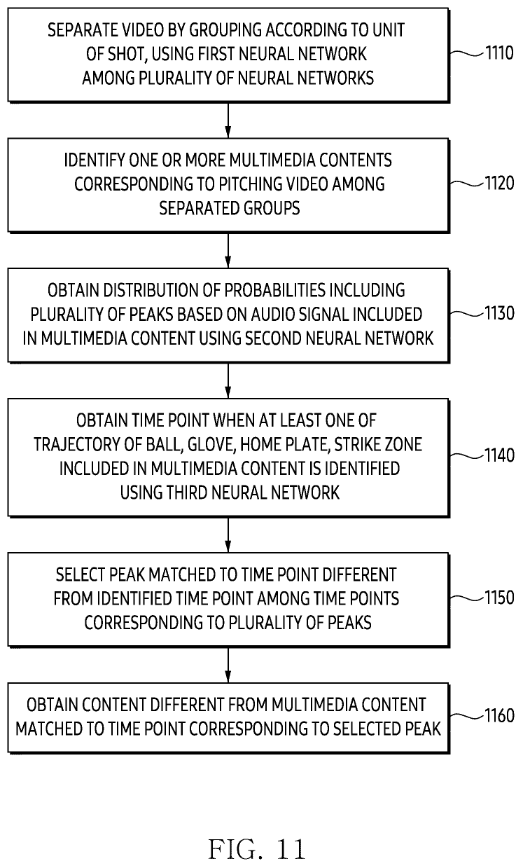

FIG. 11 is a flowchart illustrating a process in which an electronic device extracts a video in which a designated motion is captured from a video using a neural network, according to an embodiment. The operation of FIG. 11 may be performed by the electronic device 101 of FIG. 1 and/or the processor 110 of FIG. 1.

Referring to FIG. 11, in operation 1110, a processor according to an embodiment may separate a video by grouping according to a unit of shot or shots, using a first neural network among a plurality of neural networks. For example, the first neural network may be referred to the third neural network 153 of FIG. 1. The video may be matched to the video 310 of FIG. 3. The video separated by grouping according to a unit of shot or shots may be matched to the video 330 in a unit of shot or shots of FIG. 3. In an example, the processor may separate the video by grouping a pitching video, an advertisement video, a fine play video, an advertisement video, a stand video, and/or a dugout video.

Referring to FIG. 11, in operation 1120, the processor according to an embodiment may identify one or more multimedia contents corresponding to the pitching video among the separated groups. The one or more multimedia contents corresponding to the pitching video may include at least one of the pitching video 331 of FIG. 3 or the batting video 333 of FIG. 3. For example, the processor may extract the batting video, the pitching video, the advertisement video, the dugout video, and/or the stand video from the video based on a neural network.

Referring to FIG. 11, in operation 1130, the processor according to an embodiment may obtain a distribution of probabilities including a plurality of peaks based on an audio signal included in the multimedia content using a second neural network. The second neural network may be referred to the first neural network 151 of FIG. 1. The audio signal may include the audio signal 410 of FIG. 4 and/or the characteristic information 430 of FIG. 4. The distribution of probabilities including the plurality of peaks may be included in the information 450 of FIG. 4, the information 610 of FIG. 6A, the information 630 of FIG. 6B, and/or the information 650 of FIG. 6C. The plurality of peaks may include the peak value 470 of FIG. 4. The plurality of peaks may be matched to the plurality of peaks 653 and 655 of FIG. 6C.

Referring to FIG. 11, in operation 1140, the processor according to an embodiment may obtain a time point when at least one of a trajectory of a ball, a glove, home plate, and a strike zone included in the multimedia content is identified using a third neural network. The third neural network may be referred to the second neural network 152 of FIG. 1. The trajectory of the ball may be referred to the trajectory 724 of FIG. 7. The glove may be matched to the glove 722 of FIG. 7. The home plate may be referred to the home plate 723 of FIG. 7. The strike zone may be referred to the strike zone 725 of FIG. 7. The time point when the at least one is identified may be included in the first section 830 of FIG. 8.

Referring to FIG. 11, in operation 1150, the processor according to an embodiment may select a peak matched to a time point different from the identified time point among time points corresponding to the plurality of peaks. The time point different from the identified time point may be included in the second section 850 of FIG. 8. The peaks matched to the different time point may be referred to the peak 655 of FIG. 8.

Referring to FIG. 11, in operation 1160, the processor according to an embodiment may obtain content different from the multimedia content matched to the time point corresponding to the selected peak. The processor may obtain the time point corresponding to the selected peak, based on at least one neural network (e.g., the first neural network 151 of FIG. 1), using Equation 1 and/or Equation 2. The corresponding time point may mean a time domain matched from the first time point 451 of FIG. 4 to the second time point 452 of FIG. 4. The different content may include at least one of the pitching video, the catching video, and the batting video. The obtained content different from the multimedia content may be displayed on a display of the electronic device or a display device associated with the electronic device at the instruction of the processor or the electronic device.

According to an embodiment of the present disclosure, the processor, such as processor 110 or electronic device 101 may generate a video snippet or a highlight video based on the identified time point. For example, a video snippet or highlight video may be generated using the video signal synchronized to the audio signal based on the identified time point. In one example, the video snippet or highlight video may include video signal a predetermined time before and after the identified time point. As another example, the generated video may include content different from the multimedia content matched to the identified time point, e.g., content identified in process of FIG. 11. It is understood that the disclosure is not limited thereto.

As described above, the processor of the electronic device according to an embodiment may group a video into a video in a unit of shot or shots based on a neural network. The processor may obtain pitching video information, using a video signal included in the video based on another neural network, by receiving some of the grouped video in a unit of shot or shots. The processor may adjust the obtained pitching video information based on the other neural network, using the audio signal included in the video. The processor may provide the adjusted pitching video information to a user.

According to an embodiment, an electronic device may comprise memory for storing instructions, and at least one processor operably coupled to the memory. The at least one processor, when the instructions are executed, is configured to receive a request for detecting a time point when a designated motion is captured from multimedia content. The at least one processor is configured to obtain a distribution of probabilities that the designated motion is performed in a time domain, based on an audio signal in the multimedia content. The at least one processor is configured to, based on identifying a plurality of peak values within the distribution of probabilities, obtain a single time point when the designated motion is captured, from among a plurality of time points corresponding to the plurality of peak values, using a video signal synchronized to the audio signal, in the multimedia content.

For example, at least one peak value from among the plurality of peak values, matches to the largest value from among a plurality of values included between a first time point and a second time point matching to a threshold value within the distribution of probabilities. The at least one processor, when the instructions are executed, may be configured to obtain the distribution of probabilities corresponding to the time domain using probabilities where the plurality of peak values is identified, included in characteristic information, based on the audio signal, using a neural network.

For example, the neural network may be a first neural network. The at least one processor, when the instructions are executed, may be configured to, using a second neural network different from the first neural network, obtain the video signal, based on identifying at least one of a trajectory of a ball, a position of a glove, home plate, or a strike zone, from the multimedia content.

For example, the characteristic information may be based on at least one of frequency or amplitude of the audio signal, from the audio signal, in the time domain.

For example, the first time point may be a time point when a slope of the distribution of probabilities is positive. The second time point may be a time point when a slope of the distribution of probabilities is negative.

For example, the at least one processor, when the instructions are executed, may be configured to obtain content different from the multimedia content, segmented from the video signal during time from the first time point to the second time point. The time may include a single time point when the designated motion is captured.

For example, the at least one processor, when the instructions are executed, may be configured to obtain at least one of a pitching screen or a catching screen from the multimedia content using a third neural network.

For example, at least one peak value from among the plurality of peak values may correspond to a time point when sound that is caused by contact of a ball with an external object including a glove or a bat, included in the video signal is captured. The designated motion may include a motion of throwing the ball, or a motion of the ball contacting the glove or the bat.

For example, the at least one processor, when the instructions are executed, may be configured to identify at least one value below a threshold value within the distribution of probabilities, from the video signal. The at least one processor may be configured to identify, in the time domain, the largest value from the at least one value below the threshold value included in the characteristic information, as a peak value. The at least one processor, when the instructions are executed, may be configured to obtain a time point corresponding to the identified peak value.

For example, the at least one processor, when the instructions are executed, may be configured to identify one peak value exceeding a threshold value within the distribution of probabilities, from the video signal. The at least one processor, when the instructions are executed, may be configured to obtain a time point corresponding to the one peak value.

According to an embodiment, a method of an electronic device may comprise receiving a request for detecting a time point when a designated motion is captured from multimedia content. The method of the electronic device may comprise obtaining a distribution of probabilities that the designated motion is performed in a time domain, based on an audio signal in the multimedia content. The method of the electronic device may comprise, based on identifying a plurality of peak values within the distribution of probabilities, obtaining a single time point when the designated motion is captured, from among a plurality of time points corresponding to the plurality of peak values, using a video signal synchronized to the audio signal, in the multimedia content.

For example, at least one peak value from among the plurality of peak values, may match to the largest value from among a plurality of values included between a first time point and a second time point matching to a threshold value within the distribution of probabilities. The method of the electronic device may comprise obtaining the distribution of probabilities corresponding to the time domain using probabilities where the plurality of peak values is identified, included in characteristic information, based on the audio signal, using a neural network.

For example, the neural network may be a first neural network. The method of the electronic device may comprise, using a second neural network different from the first neural network, obtaining the video signal, based on identifying at least one of a trajectory of a ball, a position of a glove, home plate, or a strike zone, from the multimedia content.

For example, the characteristic information may be based on at least one of frequency or amplitude of the audio signal, from the audio signal, in the time domain.

For example, the first time point may be a time point when a slope of the distribution of probabilities is positive. The second time point may be a time point when a slope of the distribution of probabilities is negative.

For example, the method may comprise obtaining a content different from the multimedia content, segmented from the video signal during time from the first time point to the second time point. The time may include a single time point when the designated motion is captured.

For example, the method may comprise obtaining at least one of a pitching screen or a catching screen from the multimedia content using a third neural network.

A method of an electronic device may comprise receiving a request for detecting a time point when a designated motion is captured from multimedia content. The method of the electronic device may comprise, based on the receiving the request, identifying a time point when sound caused by the designated motion is captured, within an audio signal in the multimedia content. The method of the electronic device may comprise, in response to identifying a time point less than a threshold value within the audio signal, outputting information indicating that the identified time point is a time point when the designated motion is captured. The method of the electronic device may comprise, in response to identifying time points above the threshold value within the audio signal, based on a video signal within different time intervals including the time points, selecting a time point from among the time points as a time point when the designated motion is captured.

For example, the method of the electronic device may comprise obtaining a distribution of probabilities where the time points above the threshold value are identified, based on the audio signal, using a neural network. The method of the electronic device may comprise obtaining content different from the multimedia content, including a time point when the designated motion is captured, based on the video signal, using the distribution of probabilities.

For example, the sound caused by the designated motion may be sound generated by contact of a ball with at least one external object. The designated motion may include at least one of a motion of throwing the ball, or a motion of catching the ball.

The device described above may be implemented as a hardware component, a software component, and/or a combination of a hardware component and a software component. For example, the devices and components described in the embodiments may be implemented using one or more general-purpose computers or special-purpose computers, such as a processor, controller, arithmetic logic unit (ALU), digital signal processor, a microcomputer, a field programmable gate array (FPGA), a programmable logic unit (PLU), a microprocessor, or any other device capable of executing and responding to instructions. The processing device may perform an operating system (OS) and one or more software applications executed on the operating system. In addition, the processing device may access, store, manipulate, process and generate data in response to the execution of the software. For convenience of understanding, although one processing device is described as being used, but a person with ordinary knowledge in the art may see that the processing device may include multiple processing elements and/or multiple types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or command a processing device independently or collectively. The software and/or data may be permanently or temporarily embodied in any type of a machine, component, physical device, virtual device, computer storage medium or device, or transmitted signal wave to be interpreted by the processing device or to provide command or data to the processing device. The software may be stored or executed in a distributed method by being distributed on a network-connected computer system. The software and data may be stored in one or more computer readable medium.

The method according to the embodiment may be implemented in the form of a program command that may be performed through various computer means and recorded on a computer readable medium. The computer readable medium may include a program command, a data file, a data structure, and the like alone or in combination. The program commands recorded in the medium may be specially designed and configured for embodiments or may be known to and used by those skilled in computer software. Examples of the computer readable recording medium include magnetic media such as a hard disk, floppy disk and magnetic tape, optical media such as a CD-ROM and DVD, magneto-optical media such as a floptical disk, and hardware devices which store a program command such as ROM, RAM, and flash memory, and the like. Examples of the program command include a machine language code, such as those made by a compiler, as well as an advanced language code that may be executed by a computer using an interpreter or the like. The hardware device described above may be configured to operate as one or more software modules to perform the operations of the embodiment, and vice versa.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. An electronic device comprising:
memory for storing instructions; and
at least one processor operably coupled to the memory,
wherein the at least one processor, when the instructions are executed, is configured to:
receive a request for detecting a sound time point in a multimedia content when a designated motion is captured;
obtain a distribution of probabilities in a time domain that the designated motion is performed based on an audio signal in the multimedia content, wherein the distribution of probabilities comprises a plurality of peak values corresponding to respective time points in the multimedia content; and
obtain the sound time point when the designated motion is captured from among the respective time points corresponding to the plurality of peak values, using a video signal synchronized to the audio signal, in the multimedia content.

2. The electronic device of claim 1,
wherein at least one peak value from among the plurality of peak values is equal to a largest value, the largest value being a value from among a plurality of values included between a first time point and a second time point, the first time point having a first value and the second time point having a second value equal to a threshold value within the distribution of probabilities, and
wherein the at least one processor, when the instructions are executed, is further configured to:
obtain the distribution of probabilities in the time domain using probabilities where the plurality of peak values is identified, based on characteristic information and the audio signal, using a neural network.

3. The electronic device of claim 2,
wherein the neural network is a first neural network, and
wherein the at least one processor, when the instructions are executed, is further configured to:
obtain the video signal, based on identifying at least one of a trajectory of a ball, a position of a glove, home plate, or a strike zone, from the multimedia content, using a second neural network different from the first neural network.

4. The electronic device of claim 2,
wherein the characteristic information is based on at least one of frequency or amplitude of the audio signal in the time domain.

5. The electronic device of claim 2,
wherein the first time point is a time point when a slope of the distribution of probabilities is positive, and
wherein the second time point is a time point when the slope of the distribution of probabilities is negative.

6. The electronic device of claim 5,
wherein the at least one processor, when the instructions are executed, is further configured to:
obtain content different from the multimedia content, segmented from the video signal during time from the first time point to the second time point, and
wherein the time includes the sound time point when the designated motion is captured.

7. The electronic device of claim 3,
wherein the at least one processor, when the instructions are executed, is further configured to:
obtain at least one of a pitching screen or a catching screen from the multimedia content using a third neural network.

8. The electronic device of claim 1,
wherein at least one peak value from among the plurality of peak values corresponds to a time point when sound included in the video signal is captured, the sound being caused by contact of a ball with an external object, wherein the external object is one of a glove or a bat, and
wherein the designated motion comprises a first motion of throwing the ball or a second motion of the ball contacting the glove or the bat.

9. The electronic device of claim 1,
wherein the at least one processor, when the instructions are executed, is further configured to:
identify at least one value higher than a threshold value within the distribution of probabilities, from the video signal;
identify, in the time domain, a largest value from the at least one value higher than the threshold value as a peak value; and
obtain a time point corresponding to the identified peak value.

10. The electronic device of claim 2,
wherein the at least one processor, when the instructions are executed, is further configured to:
identify the at least one peak value exceeding the threshold value within the distribution of probabilities, from the video signal; and
obtain a time point corresponding to the at least one peak value.

11. A method of identifying a time point in a multimedia content, the method being executed by at least one processor of an electronic device, the method comprising:
receiving a request for detecting a sound time point in the multimedia content when a designated motion is captured;
obtaining a distribution of probabilities in a time domain that the designated motion is performed based on an audio signal in the multimedia content, wherein the distribution of probabilities comprises a plurality of peak values corresponding to respective time points in the multimedia content; and
obtaining the sound time point when the designated motion is captured from among the respective time points corresponding to the plurality of peak values, using a video signal synchronized to the audio signal, in the multimedia content.

12. The method of claim 11,
wherein at least one peak value from among the plurality of peak values is equal to a largest value, the largest value being a value from among a plurality of values included between a first time point and a second time point, the first time point having a first value and the second time point having a second value equal to a threshold value within the distribution of probabilities, and
wherein the method further comprises:
obtaining the distribution of probabilities in the time domain using probabilities where the plurality of peak values is identified, based on characteristic information and the audio signal, using a neural network.

13. The method of claim 12,
wherein the neural network is a first neural network, and
wherein the method further comprises:
obtaining the video signal, based on identifying at least one of a trajectory of a ball, a position of a glove, home plate, or a strike zone, from the multimedia content, using a second neural network different from the first neural network.

14. The method of claim 12,
wherein the characteristic information is based on at least one of frequency or amplitude of the audio signal in the time domain.

15. The method of claim 12,
wherein the first time point is a time point when a slope of the distribution of probabilities is positive, and
wherein the second time point is a time point when the slope of the distribution of probabilities is negative.

16. The method of claim 15, further comprising:
obtaining a content different from the multimedia content, segmented from the video signal during time from the first time point to the second time point, and
wherein the time includes the sound time point when the designated motion is captured.

17. The method of claim 13, further comprising:
obtaining at least one of a pitching screen or a catching screen from the multimedia content using a third neural network.

18. A method of identifying one or more time points in a multimedia content, the method being executed by at least one processor of an electronic device, the method comprising:
receiving a request for detecting a sound time point in a multimedia content when a designated motion is captured;
based on the receiving the request, identifying the sound time point when sound caused by the designated motion is captured, within an audio signal in the multimedia content;
in response to identifying a time point having a value less than a threshold value within the audio signal, outputting information indicating that the identified time point is the sound time point when the designated motion is captured; and
in response to identifying one or more time points having values above the threshold value within the audio signal and based on a video signal within different time intervals including the one or more time points, selecting a time point from among the one or more time points as the sound time point when the designated motion is captured.

19. The method of claim 18, further comprising:
obtaining a distribution of probabilities in a time domain, wherein the one or more time points above the threshold value are identified in the distribution of probabilities, wherein the distribution of probabilities is based on the audio signal and obtained using a neural network; and
obtaining content different from the multimedia content, including the sound time point when the designated motion is captured, based on the video signal, using the distribution of probabilities.

20. The method of claim 18,
wherein the sound caused by the designated motion is a sound generated by contact of a ball with at least one external object, and
wherein the designated motion includes at least one of a motion of throwing the ball, or a motion of catching the ball.
